(19) United States
(12) Patent Application Publication
(10) Pub. No.: US 2024/0386746 A1
(43) Pub. Date: Nov. 21, 2024

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventors: SHIGEO KODAMA, Tokyo (JP); TSEWEI CHEN, Tokyo (JP); MASAMI KATO, Kanagawa (JP)

(21) Appl. No.: 18/660,060

(22) Filed: May 9, 2024

(30) Foreign Application Priority Data
May 16, 2023 (JP) 2023-080921

(51) Int. Cl. G06V 40/16; G06V 10/40; G06V 10/77; G06V 10/82

(52) U.S. Cl. CPC G06V 40/165; G06V 10/40; G06V 10/7715; G06V 10/82; G06V 40/171

(57) ABSTRACT

An information processing apparatus comprises one or more processors which execute instructions stored in one or more memories, wherein by execution of the instructions the one or more processors function as a first detection unit configured to detect an object in an image including that object, using a feature of that image, and a second detection unit configured to detect a portion of the object in the image, based on a selected parameter selected from a plurality of parameters based on a direction of the object detected by the first detection unit and the feature.

### BACKGROUND

### Technical Field

The present disclosure relates to an object detection technique.

### Description of the Related Art

A hierarchical computation method (pattern recognition method based on a deep learning technique) typified by convolutional neural networks (hereinafter abbreviated as CNNs) is attracting attention as an object detection method that is robust against variations in objects.

Japanese Patent Laid-Open No. 2018-151938 discloses a technique in which a learner that outputs first information related to an orientation of a face included in a target image and a learner that outputs second information related to a position of a facial component included in the target image are provided, and the second information is obtained from the target image by a second learner corresponding to the first information.

Japanese Patent Laid-Open No. 2021-196893 discloses a technique in which the parameters of an (m+1)-th stage machine learning model corresponding to an m-th stage recognition result are selected from the parameters of a plurality of machine learning models loaded into a memory according to lightweight analysis processing.

In the technique disclosed in Japanese Patent Laid-Open No. 2018-151938, by differentiating the learner that extracts the first information and the learner for obtaining the second information, it is possible to use learners that have respectively been optimized. Therefore, it is possible to obtain the first information and the second information more efficiently than when a learner capable of simultaneously outputting the first information and the second information is provided. Meanwhile, when information that is deeply related to the first information and the second information is extracted, a first learner and the second learner may each be redundantly calculating similar features, and so, computational efficiency decreases.

Further, in the technique disclosed in Japanese Patent Laid-Open No. 2021-196893, the time for loading the parameters of a machine learning model into the memory can be concealed in the computation of an m-th stage machine learning model. Meanwhile, the amount of computation of a machine learning model itself cannot be reduced, and so, the computation time of the (m+1)-th stage machine learning model cannot be reduced.

### SUMMARY

The present disclosure provides a computationally-efficient object detection technique.

According to the first aspect of the present disclosure, there is provided an information processing apparatus that includes one or more processors which execute instructions stored in one or more memories, wherein by execution of the instructions the one or more processors function as a first detection unit configured to detect an object in an image including that object, using a feature of that image; and a second detection unit configured to detect a portion of the object in the image, based on a selected parameter selected from a plurality of parameters based on a direction of the object detected by the first detection unit and the feature.

According to the second aspect of the present disclosure, there is provided an information processing method performed by an information processing apparatus, the method includes detecting an object in an image including that object, using a feature of that image; and detecting a portion of the object in the image, based on a selected parameter selected from a plurality of parameters based on a direction of the detected object and the feature.

According to the third aspect of the present disclosure, there is provided a non-transitory computer-readable storage medium storing instructions that, when executed by at least one processor, configures the at least one processor to function as a first detection unit configured to detect an object in an image including that object, using a feature of that image; and a second detection unit configured to detect a portion of the object in the image, based on a selected parameter selected from a plurality of parameters based on a direction of the object detected by the first detection unit and the feature.

Further features of the present disclosure will become apparent from the following description of exemplary embodiments with reference to the attached drawings.

### BRIEF DESCRIPTION OF THE DRAWINGS

FIG. 1 is a block diagram illustrating an example of a configuration of a CNN processing unit 201.

FIG. 2 is a block diagram illustrating an example of a hardware configuration of an information processing apparatus.

FIG. 3 is a block diagram illustrating an example of a functional configuration of a computation processing unit 103.

FIG. 4 is a diagram illustrating an example of a network configuration of a CNN.

FIG. 5 is a diagram illustrating an example of a score map 501, a region width map 502, and a region height map 503.

FIG. 6 is a block diagram illustrating an example of a functional configuration for performing face detection and facial component detection.

FIG. 7 is a flowchart of face detection and facial component detection.

FIG. 8 is a diagram illustrating an example of a score map 801, a face region width map 802, a face region height map 803, and a face orientation map 804.

FIG. 9 is a diagram illustrating an example of a configuration of data in a RAM 205.

FIG. 10 is a diagram illustrating an example of a right-eye likelihood map 1001, a left-eye likelihood map 1002, a nose likelihood map 1003, and a mouth likelihood map 1004.

FIG. 11 is a block diagram illustrating an example of a configuration of processing for learning common CNN processing 601, face detection CNN processing 602, and facial component detection CNN processing 605.

FIG. 12 is a flowchart of a method of learning according to a learning sequence 1101.

FIG. 13A is a diagram for explaining an overview of functions according to a second embodiment.

FIG. 13B is a diagram for explaining an overview of functions according to the second embodiment.

FIG. 14 is a flowchart of detection processing according to the second embodiment.

### DESCRIPTION OF THE EMBODIMENTS

Hereinafter, embodiments will be described in detail with reference to the attached drawings. Note, the following embodiments are not intended to limit the scope of the claimed disclosure. Multiple features are described in the embodiments, but limitation is not made to a disclosure that requires all such features, and multiple such features may be combined as appropriate. Furthermore, in the attached drawings, the same reference numerals are given to the same or similar configurations, and redundant description thereof is omitted.

### First Embodiment

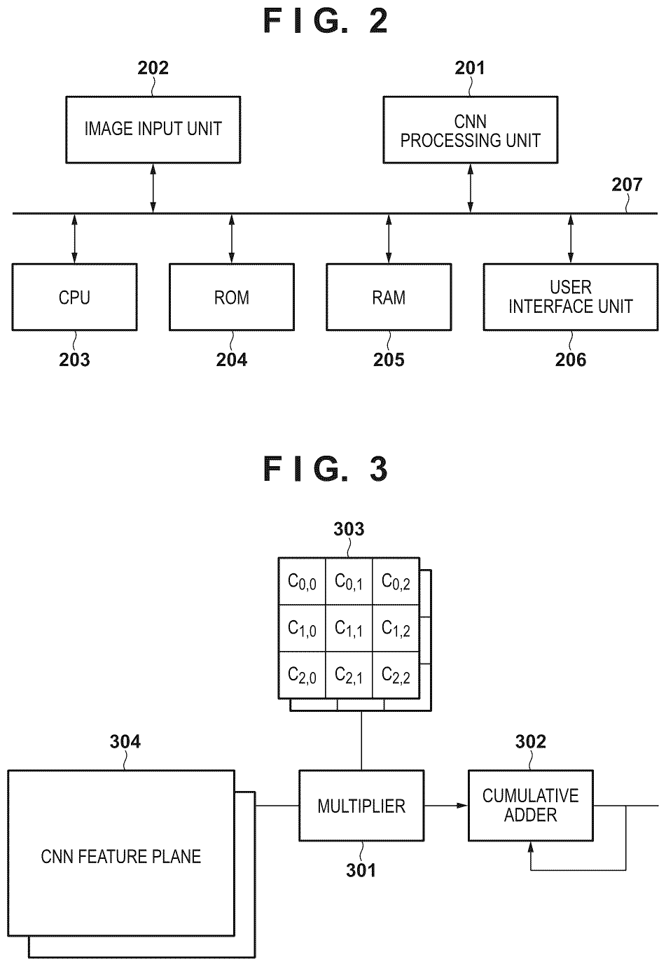

In the present embodiment, an information processing apparatus that operates as an object detector and operation thereof will be described. The information processing apparatus according to the present embodiment performs detection (face detection) of the region of a person's face in an image and detection (facial component detection) of each component (eye, nose, mouth) which is a part of that face. First, an example of a hardware configuration of the information processing apparatus according to the present embodiment will be described with reference to a block diagram of FIG. 2.

An image input unit 202 is a device for obtaining an input image. For example, the image input unit 202 may be a device that obtains an input image via a network, such as a LAN or the Internet. Further, the image input unit 202 may be an image capturing apparatus that captures a moving image and obtains the image of each frame in that moving image as an input image. Further, the image input unit 202 may be an image capturing apparatus that captures a still image and obtains that still image as an input image. When the image input unit 202 is an image capturing apparatus, that image capturing apparatus includes, for example, an optical system such as a lens, a photoelectric conversion device such as a charge-coupled device (CCD) or complementary metal oxide semiconductor (CMOS) sensor, a driver circuit that controls that photoelectric conversion device, and an A/D converter.

A CNN processing unit 201 inputs an input image obtained by the image input unit 202 to a CNN, which is an example of a hierarchical neural network, and performs computation (CNN operation) of that CNN to perform the aforementioned face detection and facial component detection. The CNN processing unit 201 will be described later in detail.

A central processing unit (CPU) 203 executes various kinds of processing using computer programs and data stored in the RAM 205. The CPU 203 thus controls the operation of the entire information processing apparatus and executes or controls various kinds of processing, which will be described as processing to be performed by the information processing apparatus.

For example, the CPU 203 executes various detection tasks based on various features obtained in detection processing in the CNN processing unit 201. Furthermore, the CPU 203 can execute various applications by utilizing results of various kinds of detection processing. For example, the CPU 203 performs comparison with a face database using a result of face detection or facial component detection to obtain information corresponding to a face or a facial component in an input image from that face database. For example, the CPU 203 can perform control such as adjusting focus on a face or a facial component in an input image by feeding back a result of face detection or facial component detection to the image input unit 202 and utilizing it for focus control of an optical system.

A read only memory (ROM) 204 stores, for example, setting data of the information processing apparatus, computer programs and data related to startup of the information processing apparatus, and computer programs and data related to a basic operation of the information processing apparatus.

A random access memory (RAM) 205 includes an area for storing computer programs and data loaded from the ROM 204 and an area for storing an input image obtained by the image input unit 202. The RAM 205 further includes a work area, which is used when the CPU 203 or the CNN processing unit 201 executes various kinds of processing. The RAM 205 can thus provide various areas as appropriate. The RAM 205 can be constituted by, for example, a high-capacity dynamic random access memory (DRAM).

A user interface unit 206 is a user interface such as a keyboard, a mouse, and a touch panel screen, and by a user operating it, various instructions can be inputted to the CPU 203.

The image input unit 202, the CNN processing unit 201, the CPU 203, the ROM 204, the RAM 205, and the user interface unit 206 are all connected to a system bus 207.

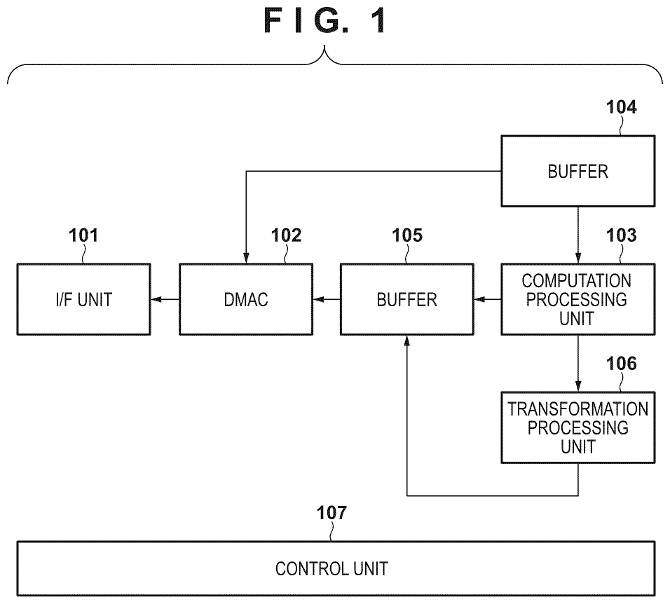

Next, an example of a configuration of the aforementioned CNN processing unit 201 will be described with reference to a block diagram of FIG. 1. In the present embodiment, functional units illustrated in FIG. 1 will be described assuming that they are all implemented in hardware but are not limited thereto and may be implemented in part by software (computer program). In the latter case, functions of functional units corresponding to that software are realized by the CPU 203 or a control unit 107 executing that software.

An I/F unit 101 functions as an interface through which the CNN processing unit 201 performs data communication with the outside and, for example, is an interface that can be accessed by the CPU 203, a DMAC 102, and the control unit 107.

The direct memory access controller (DMAC) 102 controls data transfer between the CNN processing unit 201 and the RAM 205 according to settings by the control unit 107.

A computation processing unit 103 performs a convolution operation using weight coefficients stored in a buffer 104 and a feature (computation result of a layer (previous layer) before a processing target layer in a CNN) stored in a buffer 105.

The buffer 104 is a memory that holds weight coefficients to be used in computation of a plurality of layers in a CNN and can supply those held weight coefficients to the computation processing unit 103 at a low latency. The buffer 104 can be implemented using, for example, a fast static RAM (SRAM) or a register.

The buffer 105 is a memory for storing a result of computation by the computation processing unit 103 and a result of computation by a transformation processing unit 106 and, for example, can be implemented using a high-speed SRAM or a register, as in the buffer 104.

The transformation processing unit 106 nonlinearly transforms a result (result of a predetermined convolution operation) of computation by the computation processing unit 103. Functions such as rectified linear unit (ReLU) and a sigmoid function are utilized for nonlinear transformation. In the case of ReLU, realization is possible with threshold processing, and in the case of the sigmoid function, a value is transformed using, for example, a look-up table. The control unit 107 controls operation of the entire CNN processing unit 201. The control unit 107 can be implemented using, for example, a sequencer or a simple CPU that controls the computation processing unit 103.

Here, the computation processing unit 103 will be described in more detail. In the computation processing unit 103, when a convolution operation kernel (filter-coefficient matrix) is columnSize×rowSize in size and the number of feature maps of a previous layer is L, one feature is calculated by performing a convolution operation as indicated in the following Equation (1).

$$[ EQUATION 1 ]$$

$$output ( x , y ) = {\sum }_{l = 1}^{L} {{\sum }^{rowSize / 2}}_{row = - rowSize / 2 column = -} {{\sum }^{columnSize / 2}}_{columnSize / 2} input ( x + column , y + row ) \times weight ( column , row ) \qquad ( 1 )$$

input(x, y): reference pixel value in two-dimensional coordinates (x, y)
output(x, y): result of computation in two-dimensional coordinates (x, y)
weight(column, row): weight coefficient in coordinates (column, row)
L: number of feature maps in previous layer
columnSize: horizontal size of two-dimensional convolution-operation kernel
rowSize: vertical size of two-dimensional convolution-operation kernel

Generally, in a CNN operation, by repeating product-sum operations while scanning a plurality of convolution-operation kernels according to the above Equation (1) in pixel units of an image and nonlinearly transforming (performing activation processing on) a result of the final product-sum operation, a feature map—that is, pixel data of one feature map generated by a plurality of spatial filter operations (hierarchical spatial filter operations) and a nonlinear operation on a sum thereof—is calculated.

Weight coefficients correspond to spatial filter coefficients. In practice, a plurality of feature maps are generated for each layer.

An example of a functional configuration of the computation processing unit 103 will be described with reference to a block diagram of FIG. 3. As illustrated in FIG. 3, the computation processing unit 103 includes a multiplier 301 and a cumulative adder 302 and uses the multiplier 301 and the cumulative adder 302 to execute a convolution operation of weight coefficients 303 and a feature (CNN feature plane) 304 according to the above Equation (1). The transformation processing unit 106 executes nonlinear transformation on a result of that convolution operation.

Hereinafter, since features can be represented in a format of a plurality of two-dimensional maps, they will be referred to as feature maps. In a typical CNN, the above processing is repeatedly executed for the number of generated feature maps. A calculated feature map is stored in the buffer 105.

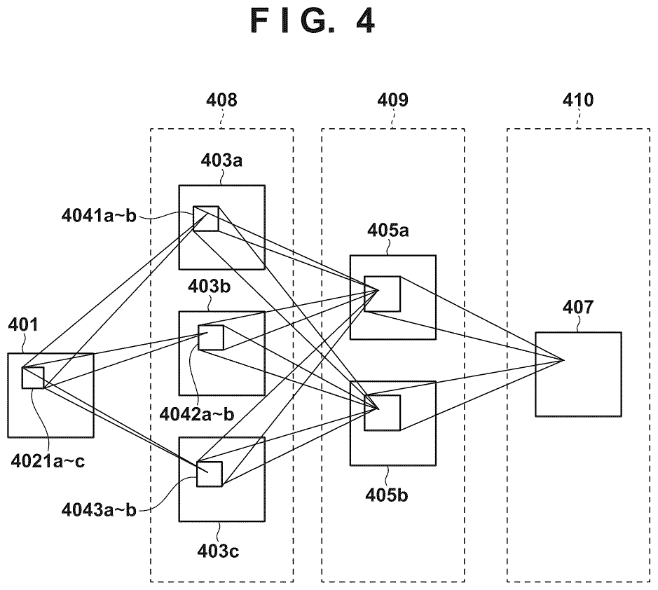

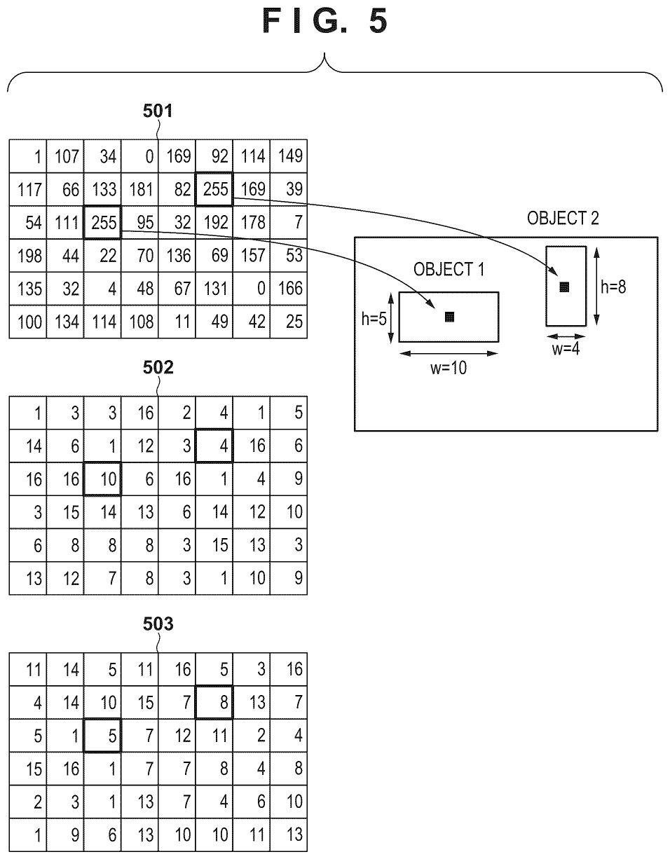

An example of a network configuration of a CNN for realizing CNN-based object detection will be described with reference to FIG. 4. Here, for the sake of descriptive convenience, a case where a small CNN (three layers) is utilized will be described. In practice, a greater number of feature planes and layers are often used.

When performing CNN operation processing on an inputted image, an input layer 401 corresponds to a raster-scanned image of a predetermined size. Feature planes 403a to 403c are feature planes of a first layer 408, feature planes 405a and 405b are feature planes of a second layer 409, and a feature plane 407 is a feature plane of a third layer 410.

A feature plane is a data plane corresponding to a processing result of a predetermined feature extraction operation (convolution operation and nonlinear processing). Since the feature plane is a processing result for a raster-scanned image, the processing result is also represented in a plane. The feature planes 403a to 403c are calculated by convolution operations and nonlinear processing corresponding to the input layer 401.

For example, the feature plane 403a is calculated by a convolution operation that uses a schematically-illustrated two-dimensional convolution kernel 4021a and nonlinear transformation on a result of that convolution operation. The feature plane 405a is a result for which convolution operations have been performed on the feature planes 403a to 403c using convolution kernels 4041a, 4042a, and 4043a, respectively, and nonlinear transformation has been performed on a sum of the results of those convolution operations.

For example, the feature plane 403b is calculated by a convolution operation that uses a schematically-illustrated two-dimensional convolution kernel 4021b and nonlinear transformation on a result of that convolution operation. The feature plane 403c is calculated by a convolution operation that uses a schematically-illustrated two-dimensional convolution kernel 4021c and nonlinear transformation on a result of that convolution operation.

The feature plane 405b is a result for which convolution operations have been performed on the feature planes 403a to 403c using convolution kernels 4041b, 4042b, and 4043b, respectively, and nonlinear transformation has been performed on a sum of the results of those convolution operations.

In a CNN, feature planes are thus sequentially computed in hierarchical processing using convolution kernels. In a case where predetermined learning has been performed, regarding the feature plane 407 of the final layer, the value of data corresponding to the position of a detection target object is higher than the values of data at other positions. In a case of determining the region of a detection target object, the value of data in the region of the detection target object is higher than the values of data in other regions.

Next, regarding the feature plane 407 of a detection target object calculated as described above, object detection is executed by searching for a location whose value is higher than a predetermined threshold using the CPU 203 or the like. A plurality of feature planes of the final layer may be generated to detect the region of a detection target object. A detection task on these feature planes is referred to as detection post-processing.

FIG. 5 illustrates an example of a score map 501, a region width map 502, and a region height map 503 of a detection target object as feature planes of the final layer, and a CNN is trained so as to output these.

The value at a respective position of the score map 501 indicates a “possibility of a detection target object” at that position and indicates a value indicating a likelihood or reliability where the value increases as the possibility of a detection target object increases. Accordingly, it is possible to set the position of a value greater than a predetermined threshold in the score map 501 as the position of a detection target object. In the example of FIG. 5, it is possible to set a position at which the value is 255 as the center position of a detection target object.

The value at a respective position of the region width map 502 indicates an “estimated width of the region of a detection target object” at that position. Accordingly, it is possible to obtain the value of a position in the region width map 502 corresponding to the center position of a detection target object identified from the score map 501 as a “width of the region of a detection target object”.

The value at a respective position of the region height map 503 indicates an “estimated height of the region of a detection target object” at that position. Accordingly, it is possible to obtain the value of a position in the region height map 503 corresponding to the center position of a detection target object identified from the score map 501 as a “height of the region of a detection target object”.

In FIG. 5, a position at which the value is “255” (position on the left side) is identified as the position of an object 1 in the score map 501 and a position at which the value is “255” (position on the right side) is identified as the position of an object 2 in the score map 501.

In addition, a value corresponding to the position of the object 1 in the region width map 502 is 10 and a value corresponding to the position of the object 1 in the region height map 503 is 5, and so, it is possible to identify the width of the region of the object 1 as 10 and the height as 5.

Similarly, a value corresponding to the position of the object 2 in the region width map 502 is 4 and a value corresponding to the position of the object 2 in the region height map 503 is 8, and so, it is possible to identify the width of the region of the object 2 as 4 and the height as 8.

Further, when a detection target object is captured large in an image or when a threshold for the score map is low, for example, a plurality of positions at which it is assumed that object detection is successful may appear close together even though there is only one detection target object. In such cases, in order to narrow down the successful detections for a detection target object to one, detection targets may be combined into one using a Non-Maximum Suppression (NMS) technique.

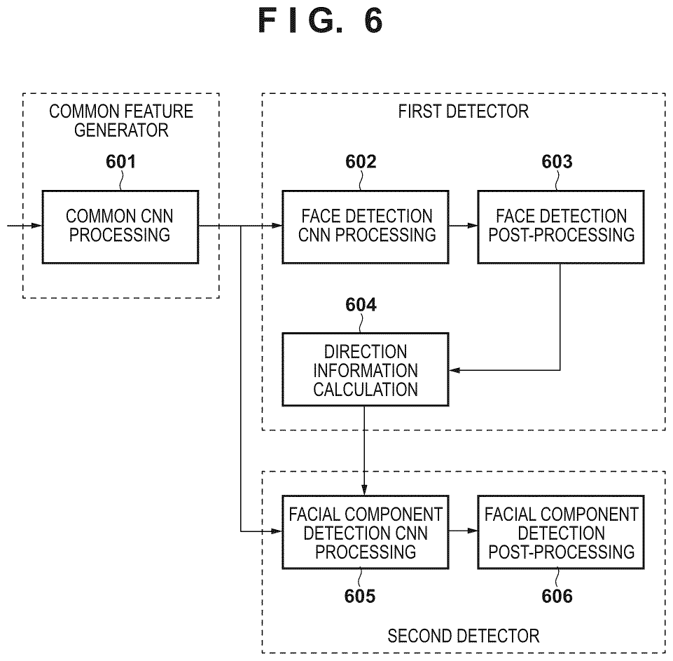

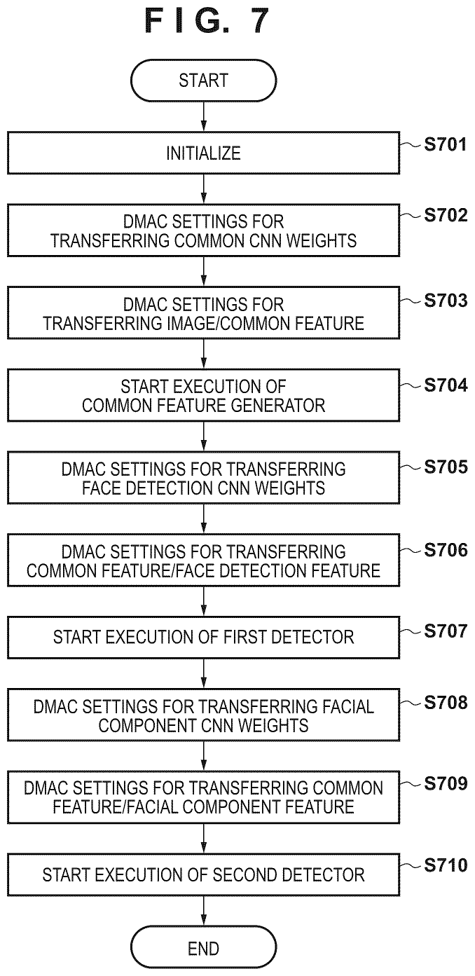

Next, an example of a functional configuration for performing face detection and facial component detection, which is realized by the CPU 203 and the CNN processing unit 201, will be described with reference to a block diagram of FIG. 6. The functional configuration realized by the CPU 203 and the CNN processing unit 201 include a common feature generator, a first detector, and a second detector. The common feature generator executes common CNN processing 601. The first detector executes face detection CNN processing 602, face detection post-processing 603, and direction information calculation 604. The second detector executes facial component detection CNN processing 605 and facial component detection post-processing 606. The face detection and facial component detection according to the present embodiment will be described according to a flowchart of FIG. 7.

In step S701, the CPU 203 executes various kinds of initialization of the CNN processing unit 201. In step S702, the control unit 107 performs DMAC settings for transferring weight coefficients (common CNN weights) necessary for performing the common CNN processing 601 from the RAM 205 to the buffer 104. Regarding the weight coefficients, those generated in advance by learning and stored in the RAM 205 may be copied and used.

In step S703, the control unit 107 performs DMAC settings for transferring an input image to be used as input data in the common CNN processing 601 and a feature (common feature) to be outputted as output data by the common CNN processing 601 between the RAM 205 and the buffer 105.

Regarding the input image, it may be directly obtained from the image input unit 202, or an input image stored in the RAM 205 may be used. The number of feature planes for common features is determined in advance by the complexity and accuracy of tasks required for object detection. It is better for it to be greater than the sum of the number of feature planes (respective feature planes representing the score, the region width, and the region height according to a face detection CNN and feature planes representing likelihoods of respective components (eyes, nose, mouth) generated by a facial component detection CNN) generated based on the common feature.

In step S704, the common feature generator executes the common CNN processing 601 and stores a result of the common CNN processing 601 in the RAM 205. More specifically, the DMAC 102 transfers the weight coefficients stored in the RAM 205 to the buffer 104 according to the DMAC settings set in step S702. Furthermore, the DMAC 102 transfers the input image stored in the RAM 205 to the buffer 105 according to the DMAC settings set in step S703. Then, a common CNN is constructed by setting the “weight coefficients stored in the buffer 104” in a CNN, and the “input image stored in the buffer 105” is inputted to that common CNN and computation (CNN operation) of that common CNN is performed to obtain a common feature. More specifically, the computation processing unit 103 performs a convolution operation using the weight coefficients stored in the buffer 104 and the input image stored in the buffer 105. The transformation processing unit 106 nonlinearly transforms a result of the convolution operation and stores a common feature, which is a result of that nonlinear transformation, in the buffer 105. The DMAC 102 transfers the common feature stored in the RAM 205 to the buffer 105 according to the DMAC settings of step S703.

In step S705, the control unit 107 performs DMAC settings for transferring weight coefficients (face detection CNN weights) for a face detection CNN from the RAM 205 to the buffer 104. In step S706, the control unit 107 performs DMAC settings for transferring a common feature to be used as input data in a face detection CNN and a face detection feature outputted as output data by that face detection CNN between the RAM 205 and the buffer 105.

In step S707, the first detector executes the face detection CNN processing 602 to determine a face detection feature and stores that determined face detection feature in the RAM 205. More specifically, the DMAC 102 transfers the weight coefficients for a face detection CNN from the RAM 205 to the buffer 104 according to the DMAC settings set in step S705. Furthermore, the DMAC 102 transfers the common feature stored in the RAM 205 to the buffer 105 according to the DMAC settings set in step S706. Then, a face detection CNN in which the “weight coefficients for a face detection CNN stored in the buffer 104” have been set in a CNN (same configuration as the CNN used in step S704) is constructed, and the “common feature stored in the buffer 105” is inputted to that face detection CNN and computation (CNN operation) of that face detection CNN is performed to obtain a face detection feature. More specifically, the computation processing unit 103 performs a convolution operation using the weight coefficients stored in the buffer 104 and the common feature stored in the buffer 105. The transformation processing unit 106 nonlinearly transforms a result of the convolution operation and stores a face detection feature, which is a result of that nonlinear transformation, in the buffer 105. The DMAC 102 transfers the face detection feature stored in the RAM 205 to the buffer 105 according to the DMAC settings of step S706.

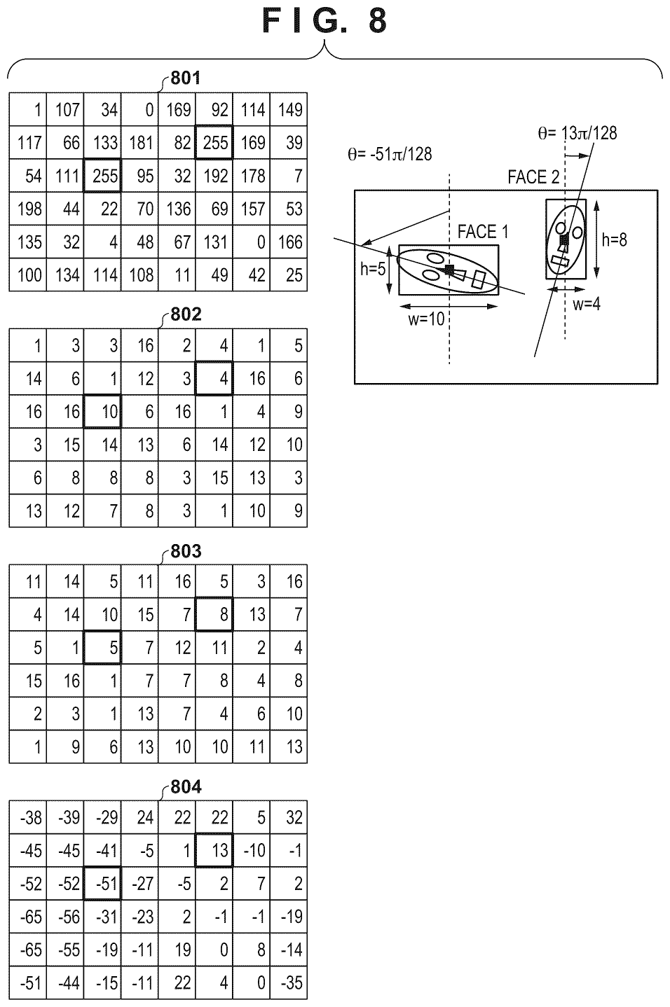

Then, the CPU 203 executes the face detection post-processing 603 and the direction information calculation 604 using the face detection feature stored in the RAM 205. The face detection post-processing 603 and the direction information calculation 604 will be described using FIG. 8 as an example.

As illustrated in FIG. 8, face detection features include a score map 801, a face region width map 802, a face region height map 803, and a face orientation map 804. The value at a respective position of the score map 801 indicates a “possibility of a face” at that position and indicates a value indicating a likelihood or reliability for which the value increases as the possibility of a face increases. Accordingly, it is possible to set the position of a value greater than a predetermined threshold in the score map 801 as the position of a face. In the example of FIG. 8, it is possible to set a position at which the value is 255 as the center position of a face.

The value at a respective position of the face region width map 802 indicates an “estimated width of the region of a face” at that position. Accordingly, it is possible to obtain the value of a position in the face region width map 802 corresponding to the center position of a face identified from the score map 801 as a “width of the region of a face”.

The value at a respective position of the face region height map 803 indicates an “estimated height of the region of a face” at that position. Accordingly, it is possible to obtain the value of a position in the face region height map 803 corresponding to the center position of a face identified from the score map 801 as a “height of the region of a face”.

The value at a respective position of the face orientation map 804 indicates an “estimated orientation of a face” at that position. Accordingly, it is possible to obtain the value of a position in the face orientation map 804 corresponding to the center position of a face identified from the score map 801 as an “orientation of a face”. The “orientation of a face” is learned such that a range of possible values is from −128 to 127 and indicates an angle clockwise with respect to the height direction of an image and multiplied by π/128.

That is, in the face detection post-processing 603, the “position of a face” is obtained as described above from the score map 801, the “width of the region of a face” is obtained as described above from the face region width map 802, the “height of the region of a face” is obtained as described above from the face region height map 803, and the “orientation of a face” is obtained as described above from the face orientation map 804.

In the example of FIG. 8, a position at which the value is “255” (position on the left side) is identified as the position of a face 1 in the score map 801 and a position at which the value is “255” (position on the right side) is identified as the position of a face 2 in the score map 801.

Then, a value “10” of a position corresponding to the position of the face 1 in the face region width map 802 is identified as the width of the region of the face 1 and a value “4” of a position corresponding to the position of the face 2 in the face region width map 802 is identified as the width of the region of the face 2.

Then, a value “5” of a position corresponding to the position of the face 1 in the face region height map 803 is identified as the height of the region of the face 1 and a value “8” of a position corresponding to the position of the face 2 in the face region height map 803 is identified as the height of the region of the face 2.

Then, a value “−51” of a position corresponding to the position of the face 1 in the face orientation map 804 is identified as the orientation (angle is −51×π/128) of the face 1. Meanwhile, a value “13” of a position corresponding to the position of the face 2 in the face orientation map 804 is identified as the orientation (angle is 13×π/128) of the face 2.

Then, in the direction information calculation 604, a combined angle is generated from the orientations of the respective faces obtained by the face detection post-processing 603. A method of generating a combined angle is not limited to a specific method. For example, an average value of the angles of the respective faces obtained in the face detection post-processing 603 may be generated as a combined angle or the angle of the face closest to the central portion of an image may be used as the combined angle. A weighted average value obtained from a weighted average of the angles of the respective faces obtained in the face detection post-processing 603 (angle of a face closer to the central portion of an image is weighted with a greater weight value) may be generated as the combined angle. Further, the magnitudes of the scores of respective faces may be used as the weight values. In a case where one orientation of a face is obtained in the face detection post-processing 603, an angle corresponding to that one orientation is set as the combined angle.

Then, “direction information for determining weight coefficients to be used by the second detector” is identified from the combined angle. In the present embodiment, four types of weight coefficients are generated in advance by learning and are stored in the RAM 205 as candidates of weight coefficients to be used by the second detector. The weight coefficients to be used by the second detector are selected from the four types of weight coefficients based on the direction information.

In the present embodiment, if the combined angle belongs to an angle range of −32π/128 to 31π/128, direction information 0 is selected as the direction information, and if the combined angle belongs to an angle range of 32π/128 to 95π/128, direction information 1 is selected as the direction information. In addition, if the combined angle belongs to an angle range of 96π/128 to 127π/128 or −128π/128 to −97π/128, direction information 2 is selected as the direction information. In addition, if the combined angle belongs to an angle range of −96π/128 to −33π/128, direction information 3 is selected as the direction information.

In the example of FIG. 8, when the average value −19π/128 of the angle −51π/128 of the face 1 and the angle 13π/128 of the face 2 is obtained as the combined angle, the direction information 0 is selected as corresponding direction information.

In step S708, the control unit 107 performs DMAC settings for transferring, among “weight coefficients corresponding to respective one of the direction information 0 to the direction information 3” stored in the RAM 205, weight coefficients (facial component CNN weights) corresponding to selected direction information (in the example of FIG. 8, the direction information 0), which has been selected in the above direction information calculation 604 of step S707, from the RAM 205 to the buffer 104.

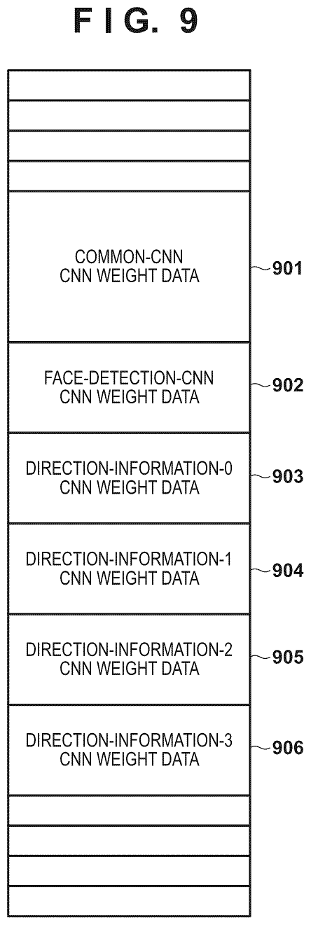

As illustrated in FIG. 9, common-CNN CNN weight data 901, which is weight coefficients for a common CNN, and face-detection-CNN CNN weight data 902, which is weight coefficients for a face detection CNN, are stored in the RAM 205. Furthermore, direction-information-0 CNN weight data 903, which is weight coefficients corresponding to the direction information 0, and direction-information-1 CNN weight data 904, which is weight coefficients corresponding to the direction information 1, are stored in the RAM 205. Furthermore, direction-information-2 CNN weight data 905, which is weight coefficients corresponding to the direction information 2, and direction-information-3 CNN weight data 906, which is weight coefficients corresponding to the direction information 3, are stored in the RAM 205.

In step S709, the control unit 107 performs DMAC settings for transferring the common feature to be used as input data in a facial component detection CNN and a facial component feature outputted as output data by that facial component detection CNN between the RAM 205 and the buffer 105.

In step S710, the second detector executes the facial component detection CNN processing 605 to obtain a facial component feature and then performs the facial component detection post-processing 606 to detect facial components from that facial component feature. More specifically, the DMAC 102 transfers weight coefficients (weight coefficients for a facial component detection CNN) corresponding to selected direction information selected in the direction information calculation 604 from the RAM 205 to the buffer 104 according to the DMAC settings set in step S708. Furthermore, the DMAC 102 transfers the common feature stored in the RAM 205 to the buffer 105 according to the DMAC settings set in step S709. Then, a facial component detection CNN in which the “weight coefficients stored in the buffer 104” have been set in a CNN (same configuration as the CNN used in step S704) is constructed, and the “common feature stored in the buffer 105” is inputted to that facial component detection CNN and computation (CNN operation) of that facial component detection CNN is performed to obtain a facial component feature. More specifically, the computation processing unit 103 performs a convolution operation using the weight coefficients stored in the buffer 104 and the common feature stored in the buffer 105. The transformation processing unit 106 nonlinearly transforms a result of the convolution operation and stores a facial component feature, which is a result of that nonlinear transformation, in the buffer 105. The DMAC 102 transfers the facial component feature stored in the RAM 205 to the buffer 105 according to the DMAC settings of step S709.

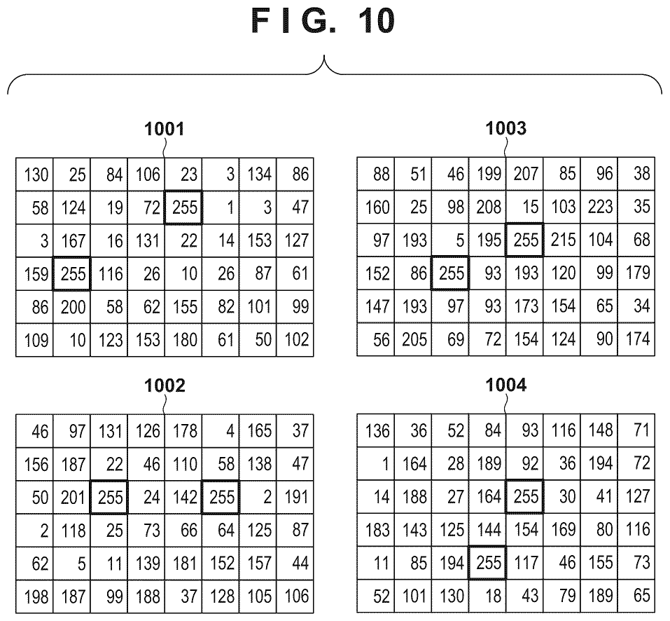

Then, the CPU 203 executes the facial component detection post-processing 606 using the facial component feature stored in the RAM 205. The facial component detection post-processing 606 will be described using FIG. 10 as an example.

As illustrated in FIG. 10, facial component features include a right-eye

likelihood map 1001, a left-eye likelihood map 1002, a nose likelihood map 1003, and a mouth likelihood map 1004.

The value at a respective position of the right-eye likelihood map 1001 indicates a “possibility of a right eye” at that position and indicates a value indicating a likelihood or reliability for which the value increases as the possibility of a right eye increases. Accordingly, it is possible to set the position of a value greater than a predetermined threshold in the right-eye likelihood map 1001 as the position of a right eye. In the example of FIG. 10, it is possible to set a position at which the value is 255 in the right-eye likelihood map 1001 as the center position of a right eye.

The value at a respective position of the left-eye likelihood map 1002 indicates a “possibility of a left eye” at that position and indicates a value indicating a likelihood or reliability for which the value increases as the possibility of a left eye increases. Accordingly, it is possible to set the position of a value greater than a predetermined threshold in the left-eye likelihood map 1002 as the position of a left eye. In the example of FIG. 10, it is possible to set a position at which the value is 255 in the left-eye likelihood map 1002 as the center position of a left eye.

The value at a respective position of the nose likelihood map 1003 indicates a “possibility of a nose” at that position and indicates a value indicating a likelihood or reliability for which the value increases as the possibility of a nose increases. Accordingly, it is possible to set the position of a value greater than a predetermined threshold in the nose likelihood map 1003 as the position of a nose. In the example of FIG. 10, it is possible to set a position at which the value is 255 in the nose likelihood map 1003 as the center position of a nose.

The value at a respective position of the mouth likelihood map 1004 indicates a “possibility of a mouth” at that position and indicates a value indicating a likelihood or reliability for which the value increases as the possibility of a mouth increases. Accordingly, it is possible to set the position of a value greater than a predetermined threshold in the mouth likelihood map 1004 as the position of a mouth. In the example of FIG. 10, it is possible to set a position at which the value is 255 in the mouth likelihood map 1004 as the center position of a mouth.

That is, in the facial component detection post-processing 606, the position of a right eye is obtained as described above from the right-eye likelihood map 1001, the position of a left eye is obtained as described above from the left-eye likelihood map 1002, the position of a nose is obtained as described above from the nose likelihood map 1003, and the position of a mouth is obtained as described above from the mouth likelihood map 1004.

In the facial component detection of the present embodiment, one position is detected for each component (right eye, left eye, nose, mouth) but a plurality of positions (e.g., inner corner of the eye, outer corner of the eye, lower eyelid, upper eyelid, pupil, etc.) may be detected for each component. Regarding a detection method, a facial component detection CNN is trained so as to output a feature map corresponding to each part, and as in the above description, it is possible to set the position of a value exceeding a predetermined threshold in a respective feature map as the detection position of a respective component.

Further, the respective detection results can be outputted in association with each other. For example, regarding association of facial component detection results, by outputting the position of the nose, which is in the vicinity of approximately the center of the face, and the position of the right eye, the left eye, and the mouth, which are in the vicinity of the position of the nose, in association with each other, it is possible to output the positions of these components as the positions of the components constituting the same face. Further, regarding association of facial component detection results and a face detection result, it is possible to output the center position of an object in the vicinity of the position of the nose as the same face.

As described above, in the present embodiment, it is possible to execute face detection and facial component detection, respectively, based on a common feature generated by the common feature generator. In addition, in the present embodiment, an example in which, when performing facial component detection, it is possible to obtain direction information from a result of face detection and use weight coefficients corresponding to the direction information has been described.

Next, a method of learning the common CNN processing 601, the face detection CNN processing 602, and the facial component detection CNN processing 605 (i.e., method of training a CNN that executes respective CNN processes) will be described. In the present embodiment, learning is performed by a method called multi-task learning. Multitask learning is a method in which a plurality of tasks that share a feature plane are simultaneously learned. In the present embodiment, face detection and facial component detection tasks are learned simultaneously. The learning of the common CNN processing 601, the face detection CNN processing 602, and the facial component detection CNN processing 605 may be performed by an information processing apparatus or may be performed by another device different from the information processing apparatus. In the latter case, weight coefficients, which are the results of learning, are stored in the RAM 205 of the information processing apparatus.

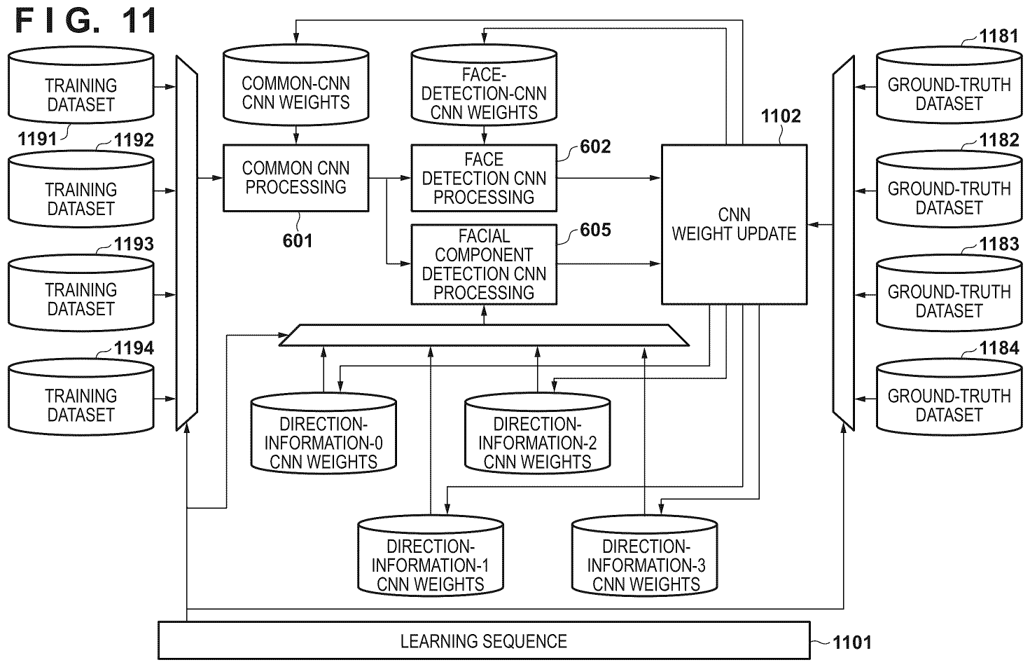

An example of a configuration of processing for learning the common CNN processing 601, the face detection CNN processing 602, and the facial component detection CNN processing 605 will be described with reference to a block diagram of FIG. 11. In the present embodiment, learning targets are the common CNN processing 601, the face detection CNN processing 602, and the facial component detection CNN processing 605. The weight coefficients of a CNN that executes the common CNN processing 601 can be obtained by learning the common CNN processing 601, and the weight coefficients of a CNN that executes the face detection CNN processing 602 can be obtained by learning the face detection CNN processing 602. Further, the weight coefficients of a CNN that executes the facial component detection CNN processing 605 can be obtained by learning the facial component detection CNN processing 605.

In learning, a training dataset is inputted into a CNN and computation of that CNN is performed, and a result of the computation is compared with a ground-truth dataset corresponding to the training dataset and prepared in advance, and the weight coefficients of the CNN is updated (CNN weight update 1102) based on a result of the comparison.

The training dataset includes a training dataset 1191 corresponding to the direction information 0, a training dataset 1192 corresponding to the direction information 1, a training dataset 1193 corresponding to the direction information 2, and a training dataset 1194 corresponding to the direction information 3. The ground-truth dataset corresponding to the training dataset and prepared in advance includes a ground-truth dataset 1181 corresponding to the direction information 0, a ground-truth dataset 1182 corresponding to the direction information 1, a ground-truth dataset 1183 corresponding to the direction information 2, and a ground-truth dataset 1184 corresponding to the direction information 3.

The direction information is calculated based on the orientation of a face to be detected as described above, and so, for example, the training dataset 1191 for the direction information 0 is a group of images in which a significant number of faces for which the face direction is −32π/128 to 31π/128 are captured. The ground-truth dataset 1181 for the direction information 0 is a group of ideal feature maps that are outputted when face detection and facial component detection are performed using the training dataset 1191 for the direction information 0. Even if the dataset (training dataset, ground-truth dataset) is for the direction information 0, it need not include only the face orientation −32π/128 to 31π/128 and may include other face orientations. This makes it possible to obtain a robust detection result even if there are some variations in input images. These descriptions are similar for respective training datasets and ground-truth datasets of the direction information 1, 2, and 3.

In the CNN weight update 1102, a typical method is to use

backpropagation, and various methods may be used for efficient learning. The learning sequence 1101 controls the entire learning.

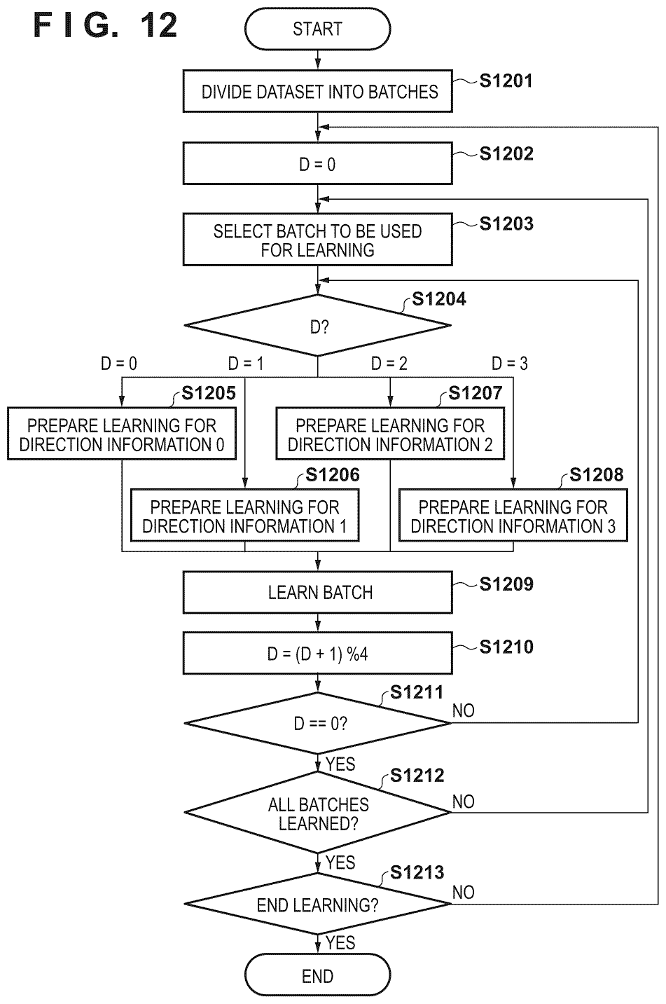

A method of learning according to the learning sequence 1101 will be described according to a flowchart of FIG. 12. In step S1201, each type of dataset is divided into batches constituted by a plurality of pieces of data. Regarding the units into which they are divided, they are divided into batches such that the training dataset and the ground-truth dataset correspond. In the present embodiment, these batches are units at which learning is switched for each piece of direction information.

In step S1202, the value of a variable D indicating direction information is initialized to 0. In step S1203, a batch to be used for learning is selected. In step S1204, the processing branches out according to the direction information.

Regarding the processing from step S1205 to step S1208, respective learning preparations are performed depending on the value of the variable D. Specifically, the batch selected in step S1203 is set to be used in learning, and the weight coefficients for the facial component detection CNN processing 605 are switched according to the value of the variable D. At this time, by not switching the weight coefficients of the common CNN processing 601, and the face detection CNN processing 602 regardless of the value of the variable D, learning progresses for the common CNN processing 601 and the face detection CNN processing 602 independent of the value of the variable D.

That is, if the value of the variable D=0, the processing proceeds to step S1205 via step S1204. In step S1205, a batch corresponding to the direction information 0 is set to be used in learning, and weight coefficients corresponding to the direction information 0 are set as weight coefficients for the facial component detection CNN processing 605.

If the value of the variable D=1, the processing proceeds to step S1206 via step S1204. In step S1206, a batch corresponding to the direction information 1 is set to be used in learning, and weight coefficients corresponding to the direction information 1 are set as weight coefficients for the facial component detection CNN processing 605.

If the value of the variable D=2, the processing proceeds to step S1207 via step S1204. In step S1207, a batch corresponding to the direction information 2 is set to be used in learning, and weight coefficients corresponding to the direction information 2 are set as weight coefficients for the facial component detection CNN processing 605.

If the value of the variable D=3, the processing proceeds to step S1208 via step S1204. In step S1208, a batch corresponding to the direction information 3 is set to be used in learning, and weight coefficients corresponding to the direction information 3 are set as weight coefficients for the facial component detection CNN processing 605.

In step S1209, learning in which the set batch is used is executed using a CNN in which the set weight coefficients have been set. Learning is performed by performing face detection and facial component detection using images included in the batch and feeding back a difference between a feature map and a ground-truth feature map of a result thereof to the weight coefficients.

In step S1210, the value of the variable D is incremented by one, and the incremented value modulo 4 is set as the value of the variable D. In step S1211, it is determined whether the value of the variable D is 0. If the value of the variable D is 0, it means that a full set of learning has been executed for the direction information 0 to 3. If the value of the variable D is 0, the processing proceeds to step S1212, and if the value of the variable D is not 0, the processing proceeds to step S1204.

In step S1212, it is determined whether learning has been completed for all batches. If learning has been completed for all batches, the processing proceeds to step S1213, and if a batch for which learning has not been completed remains, the processing proceeds to step S1203.

In step S1213, it is determined whether a condition for ending learning has been satisfied. The condition for ending learning is not limited to a specific condition and is, for example, the number of times of learning is greater than or equal to a threshold, a time elapsed from the start of learning is greater than or equal to a threshold, the aforementioned difference is less than a threshold, the amount of change in the aforementioned difference is less than a threshold, and the like. When the condition for ending learning is satisfied, the processing according to the flowchart of FIG. 12 ends, and when the condition for ending learning is not satisfied, the processing proceeds to step S1202.

By such a learning method, it is possible to obtain weight coefficients with which it is possible to detect a face and facial components for the common CNN processing 601, the face detection CNN processing 602, and the facial component detection CNN processing 605.

In CNN processing, it is thought that an object is detected by automatically extracting local features of an object in an image in the first place and consolidating these hierarchically. Therefore, the CNN processing that attempts to detect a face generates parts, such as facial components which constitute the face, according to learning as an intermediate feature. The present embodiment utilizes this phenomenon, and learning is advanced so that a feature of components of a detection object generated in the middle of a detection task is the common feature to be outputted by the common CNN. Accordingly, when performing a face detection task and a facial component detection task, it is possible to consolidate computations in which the common feature is calculated into one, and it is possible to reduce the amount of computation. In addition, it is known that a similar effect can be obtained even if the learning of the facial component detection CNN and the learning of the common CNN and the face detection CNN are individually performed using different datasets instead of multi-task learning as in the present embodiment.

In addition, the facial component detection CNN can use weight coefficients learned in advance according to a database that matches direction information obtained from a face detection result. The direction information obtained from a face orientation generally coincides with the orientation of facial components included in the face, and each facial component is almost fixed in position and size in the face as well as shape. Accordingly, it is possible to limit variations in input to be detected in the facial component detection CNN. As described above, by making the common CNN and the face detection CNN learn a robust dictionary that is independent of the orientation and the like of an object and decreasing robustness for the facial component detection CNN, which performs a more detailed detection, and making it learn a dictionary for each variation, it is possible to configure a minimum essential network.

In the present embodiment, a face orientation has been described using a two-dimensional direction in an image plane as an example, but in a three-dimensional space, a roll angle (in-plane rotation), a pitch angle, and a yaw angle are included, and these can be used for detection and weight coefficient selection. In that case, it is necessary to learn weight coefficients corresponding to a roll angle, a pitch angle, and a yaw angle, respectively.

Further, in the present embodiment, an example in which the face orientation is divided into four directions every 90° has been described, but the face orientation may be divided into eight directions every 45°, for example, and the number of divisions of direction is not limited to a specific number of divisions.

### Second Embodiment

Hereinafter, differences from the first embodiment will be described, and unless particularly mentioned below, it is assumed that it is similar to the first embodiment. In the present embodiment, an information processing apparatus that operates as an object detector for detecting types of members piled on a conveyor belt and a portion (component region) in the member that can be held by a robot arm will be described.

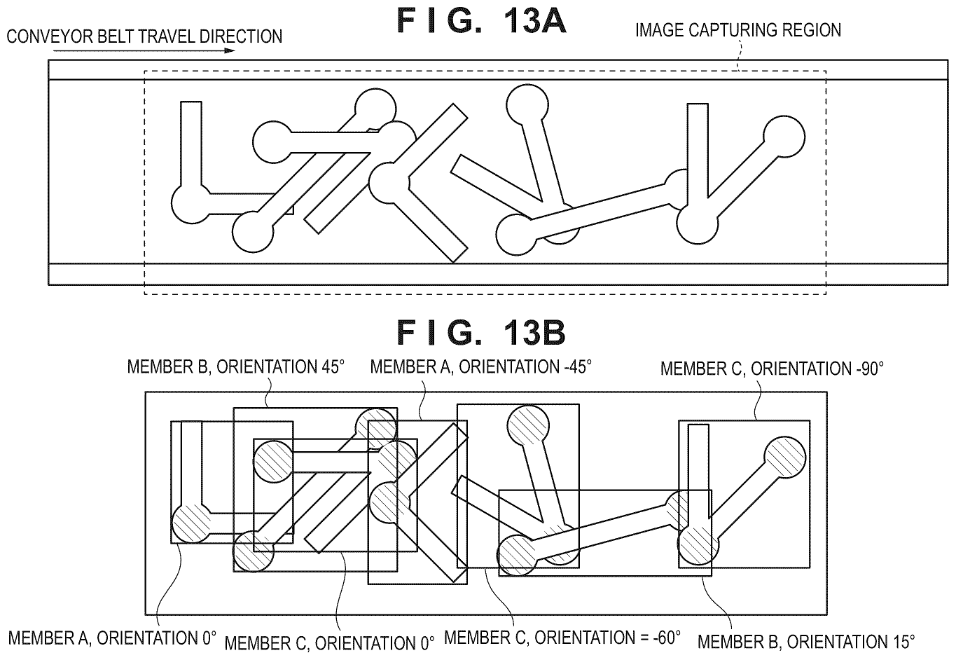

FIGS. 13A and 13B are diagrams for explaining an overview of the present function. In the present embodiment, as illustrated in FIG. 13A, it is envisioned that members conveyed on a conveyor belt in a piled state is held and sorted by a robotic arm. When a member is included in an image capturing region, an image is captured, and a type of member and a holdable component region is detected. A post-detection image is illustrated in FIG. 13B, and for each member, a type (member A, B, C) is identified and an orientation of the member is detected by the first detector, and a holdable component region (in the drawing, described by a hatched portion) is detected by the second detector.

In the present embodiment, a CNN used in the first detector is trained so as to be capable of detecting a type and orientation of a member, and these are also detected in detection post-processing. In addition, a CNN used in the second detector is trained so as to be capable of detecting a holdable component region in a member, and the holdable component region is also detected in detection post-processing. Furthermore, the common feature generator is trained so as to output a feature plane indicating a possibility that a component constituting a member is present and such that it is possible for the first detector to identify a type and orientation of a member and the second detector to detect a component region.

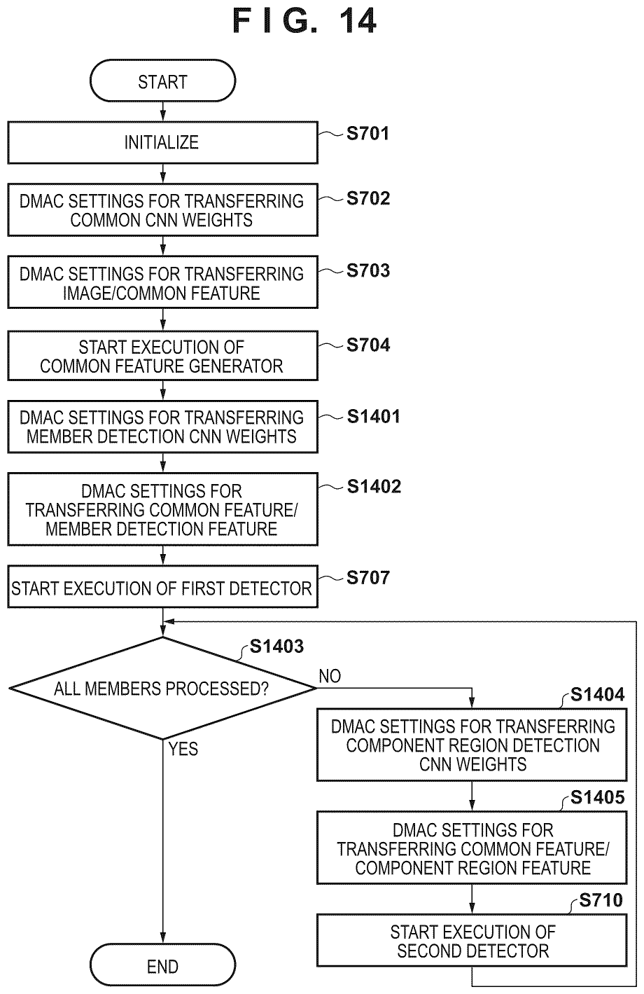

The detection processing according to the present embodiment will be described according to a flowchart of FIG. 14. In FIG. 14, the same step numerals are given to processing steps that are similar to the processing steps illustrated in FIG. 7, and description pertaining to these processing steps will be omitted.

In step S1401, the control unit 107 performs DMAC settings for transferring weight coefficients for a member detection CNN from the RAM 205 to the buffer 104. In step S1402, the control unit 107 performs DMAC settings for transferring the common feature to be used as input data in a member detection CNN and a member detection feature outputted as output data by that member detection CNN between the RAM 205 and the buffer 105.

In step S707, the first detector executes member detection CNN processing, detects members as illustrated in FIG. 13B, and detects the number and orientations of members in the image. More specifically, the DMAC 102 transfers the weight coefficients for a member detection CNN from the RAM 205 to the buffer 104 according to the DMAC settings set in step S1401. Furthermore, the DMAC 102 transfers the common feature stored in the RAM 205 to the buffer 105 according to the DMAC settings set in step S1402. Then, a member detection CNN in which the “weight coefficients for a member detection CNN stored in the buffer 104” have been set in a CNN (same configuration as the CNN used in step S704) is constructed, and the “common feature stored in the buffer 105” is inputted to that member detection CNN and computation (CNN operation) of that member detection CNN is performed to obtain a member detection feature. More specifically, the computation processing unit 103 performs a convolution operation using the weight coefficients stored in the buffer 104 and the common feature stored in the buffer 105. The transformation processing unit 106 nonlinearly transforms a result of the convolution operation and stores a member detection feature, which is a result of that nonlinear transformation, in the buffer 105. The DMAC 102 transfers the member detection feature stored in the RAM 205 to the buffer 105 according to the DMAC settings of step S1402. The member detection feature includes a map (score map, member region width map, member region height map, member orientation map) in which a target is a member and not a face in the face detection feature.

Then, the CPU 203 obtains a “position of a member”, a “width of the region of a member”, a “height of the region of a member”, and an “orientation of a member” as in the first embodiment using the member detection feature stored in the RAM 205.

In step S1403, the control unit 107 determines whether component region detection has been performed for all members detected by the first detector. As a result of this determination, when the component region detection is performed for all the members detected by the first detector, the processing according to the flowchart of FIG. 14 ends. Meanwhile, if a member for which component region detection has not yet been performed remains among the members detected by the first detector, the processing proceeds to step S1404.

In step S1404, the control unit 107 sets a member for which component region detection has not yet been performed as a target member among the members detected by the first detector. Then, the control unit 107 performs DMAC settings for transferring weight coefficients for a component region detection CNN for identifying a component region for that target member from the RAM 205 to the buffer 104. The orientation of each member is detected by the first detector. The weight coefficients for a component region detection CNN is learned from a plurality of training datasets for which the orientations of members have been roughly sorted, and when the orientation of a member is determined, it is possible to select appropriate weight coefficients. That is, the control unit 107 performs DMAC settings for transferring, as weight coefficients for a component region detection CNN for identifying a component region of a target member, weight coefficients corresponding to the direction of that target member from the RAM 205 to the buffer 104.

In step S1405, DMAC settings for transferring the common feature to be used as input data in a component region detection CNN and a component region feature outputted as output data by that the component region detection CNN between the RAM 205 and the buffer 105 are performed. The position of a member has been identified, and so, it is possible to limit a size for which calculation is to be performed for a common feature and a component region feature from the image to a vicinity of the position of the member and thereby reduce the amount of computation.

In step S1406, the second detector detects a component region of each member. More specifically, the DMAC 102 transfers weight coefficients corresponding to the direction of a target member from the RAM 205 to the buffer 104 according to the DMAC settings set in step S1404. Furthermore, the DMAC 102 transfers the common feature stored in the RAM 205 to the buffer 105 according to the DMAC settings set in step S1405. Then, a component region detection CNN in which the “weight coefficients stored in the buffer 104” have been set in a CNN (same configuration as the CNN used in step S704) is constructed, and the “common feature stored in the buffer 105” is inputted to that component region detection CNN and computation (CNN operation) of that component region detection CNN is performed to obtain a component region feature. More specifically, the computation processing unit 103 performs a convolution operation using the weight coefficients stored in the buffer 104 and the common feature stored in the buffer 105. The transformation processing unit 106 nonlinearly transforms a result of the convolution operation and stores a component region feature, which is a result of that nonlinear transformation, in the buffer 105. The DMAC 102 transfers the component region feature stored in the RAM 205 to the buffer 105 according to the DMAC settings of step S1405. The component region feature includes a map (score map, component region width map, component region height map, component orientation map) in which a target is a component and not a face in the face detection feature. Then, the CPU 203 detects a component region using the member region feature stored in the RAM 205 as in the first embodiment.

As described above, according to the present embodiment, it is possible to detect the type and orientation of a member in the first detector from the common feature outputted from the common feature generator, select appropriate weight coefficients based on the orientation of the member, and detect a holdable component region of the member. In a case where many members are captured in one image, by determining a region in which a member is present and, centered on that region, detecting the region of components constituting the member, it is possible to efficiently perform detection. Furthermore, the common feature is a feature that is common and necessary when detecting a member as well as when detecting components constituting the member, and so, by sharing these, it is possible to reduce the processing load of all tasks.

In the first and second embodiments, an example of CNN-based recognition processing has been described but is not limited thereto, and it is possible to adopt various detection algorithms. In that case, a method in which an algorithm by which a common feature is obtained and an algorithm by which a detection task is processed are different, for example, may be taken. That is, weight coefficients are merely one example of a parameter in a detection algorithm. The weight coefficients selected according to direction information are also merely one example of a selected parameter selected from a plurality of parameters based on the direction of a detected object. In addition, a face and a member are merely examples of an object to be detected, and a facial component and a component region are merely examples of a part of the object.

In the first and second embodiments, a case where a convolution operation and coefficient rotation processing are processed by hardware has been described. However, the convolution operation and coefficient rotation processing may be processed by a processor such as a CPU/graphics processing unit (GPU)/digital signal processing unit (DSP).

The numerical values, processing timing, processing order, processing entity, data (information) obtainment method/transmission destination/transmission source/storage location, and the like used in each of the above embodiments have been given as examples for the sake of providing a concrete explanation, and the present disclosure is not intended to be limited to such examples.

Further, some or all of the above-described embodiments may be appropriately combined and used. Further, some or all of the above-described embodiments may be selectively used.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-080921, filed May 16, 2023, which is hereby incorporated by reference herein in its entirety.

What is claimed is:

1. An information processing apparatus comprising:
one or more processors which execute instructions stored in one or more memories,
wherein by execution of the instructions the one or more processors function as:
a first detection unit configured to detect an object in an image including that object, using a feature of that image; and
a second detection unit configured to detect a portion of the object in the image, based on a selected parameter selected from a plurality of parameters based on a direction of the object detected by the first detection unit and the feature.

2. The information processing apparatus according to claim 1, wherein
the second detection unit generates a combined angle for which angles of directions of respective objects detected by the first detection unit have been combined and selects a parameter corresponding to an angle range to which that combined angle belongs from a plurality of parameters corresponding to a plurality of angle ranges as the selected parameter.

3. The information processing apparatus according to claim 2, wherein
the second detection unit obtains an average value of the angles of the directions of the respective objects detected by the first detection unit as the combined angle.

4. The information processing apparatus according to claim 2, wherein
the second detection unit sets an angle of a direction of an object that is the closest to a central portion of the image among the respective objects detected by the first detection unit as the combined angle.

5. The information processing apparatus according to claim 2, wherein
the second detection unit obtains a weighted average value obtained by weighted averaging of the angles of the directions of the respective objects detected by the first detection unit as the combined angle.

6. The information processing apparatus according to claim 1, wherein
for each object detected by the first detection unit, the second detection unit detects a portion of that object in the image, based on a selected parameter selected from a plurality of parameters based on a direction of that object.

7. The information processing apparatus according to claim 1, wherein
the first detection unit constructs a first hierarchical neural network in which weight coefficients for object detection have been set in a hierarchical neural network and detects the object using that first hierarchical neural network, and
the second detection unit constructs a second hierarchical neural network in which weight coefficients, which is the selected parameter, have been set in the hierarchical neural network and detects a portion of the object using the second hierarchical neural network.

8. The information processing apparatus according to claim 7, wherein execution of the stored instructions further configures the one or more processors to operate as:
a unit configured to construct a third hierarchical neural network in which weight coefficients for detecting the feature have been set in the hierarchical neural network and detect the feature using the third hierarchical neural network.

9. The information processing apparatus according to claim 1, further comprising:
a unit configured to output results of the detection by the second detection unit in association with each other.

10. The information processing apparatus according to claim 1, further comprising:
an image capturing apparatus configured to capture the image.

11. An information processing method performed by an information processing apparatus, the method comprising:
detecting an object in an image including that object, using a feature of that image; and
detecting a portion of the object in the image, based on a selected parameter selected from a plurality of parameters based on a direction of the detected object and the feature.

12. A non-transitory computer-readable storage medium storing instructions that, when executed by one or more processors, configures the one or more processors to function as:
a first detection unit configured to detect an object in an image including that object, using a feature of that image; and
a second detection unit configured to detect a portion of the object in the image, based on a selected parameter selected from a plurality of parameters based on a direction of the object detected by the first detection unit and the feature.
